(19) United States
(12) Patent Application Publication
(10) Pub. No.: US 2009/0322251 A1
(43) Pub. Date: Dec. 31, 2009

(54) LARGE AREA LIGHTING

(75) Inventor: Achim Hilgers, Alsdorf (DE)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/306,410

(22) PCT Filed: Jun. 20, 2007
(86) PCT No.: PCT/IB2007/052371

§ 371 Date: Apr. 8, 2009

(30) Foreign Application Priority Data
Jun. 27, 2006 (EP) 06116148.5

(51) Int. Cl. H05B 37/02

(52) U.S. Cl. 315/297; 315/307

(57) ABSTRACT

Within lighting tiles (2), pluralities of LEDs (8) are connected to modules (6), which are interconnected using a two-wire bus (10). This bus transmits (10) both power as well as control information for driving the modules (6) and thus the LEDs (8). The bus (10) provides for reduced wiring requirements and enables a variety of lighting effects through a central controller (4).

The invention relates to the field of lighting devices.

Document US 2005/0134525 A1 shows a method for controlling a modular, tiled, large-screen emissive display. In this reference, emissive devices, such as organic light emitting diodes (OLED), are comprised in a plurality of first subdivisions. For each of the first subdivisions, the emissive devices are set so that each of the first subdivisions is optimized with respect to a first subdivision target value. After having set the emissive devices, the first subdivisions are set so that the emissive display is optimized with respect to an emissive display target value. Thus, controlling a tiled, large-screen emissive display with a plurality of first subdivisions, which may be grouped into a plurality of second subdivisions, is provided.

The illustrated control system performs operations to initialize and configure emissive display systems during their physical assembly and during operation. The emissive display tiles may be addressed and controlled for uniform image display and proper image size. For driving the emissive devices, a power signal is provided to each of the subdivisions. Separated from the power line, there is provided a DATA IN signal, which is distributed to all subdivisions in one row. Each subdivision has a data input connector for receiving video data signals containing the current video frame information to be displayed on the display.

It is found, that the reference shows the drawback of complex wiring-structure, as each light source is separately fed with a power line and a data line. This provides for a complicated control circuitry and increases costs of such devices.

It would therefore be advantageous to achieve a lighting device with reduced wiring requirements.

To provide for lighting devices with less wiring requirements, in a first aspect of the present patent application, there is provided a lighting device comprising at least one controller controlling at least one module with at least one light source, and an electrical connection between the controller and the module, wherein the electrical connection carries both power supply, and control information between the controller and the module. By providing both power and control within one single electrical connection, the wiring requirements are reduced, thus reducing costs and complexity of lighting devices.

According to embodiments, the electrical connection is a bus. The bus may be an electrical connection, with which all of the modules are connected. Control information can be provided in parallel, and serially on the bus to all of the modules. The bus allows for scaling the lighting device, i.e. adding any number of modules to the device in order to increase, for example, the size of the lighting area. The bus may be, for example, a two-wire bus, thus further reducing wiring requirements. In this case, it is possible that control information is provided serially on the bus and that the modules are connected in parallel on the bus.

The parallel connection of the modules to the electrical connection is preferred, according to embodiments. Depending on the number and type of light sources connected to the electrical connection, power consumption may vary. Different power consumption may be accounted for providing more or less power on the electrical connection. It may be possible to provide for different types of controllers, each of which provides different power to the electrical connection, thus enabling various configurations of modules on the electrical connection.

To provide for monitoring and controlling the modules, embodiments provide the electrical connection as bi-directional connection. This provides for transferring control information to and from the controller to the modules. Thus, the controller can monitor the status of each of the modules and can control their operation. This increases flexibility for the lighting device.

Embodiments provide modulating the control information with a high frequency signal onto the electrical connection. Preferred modulations may be frequency modulation (FM), amplitude modulation (AM), pulse modulation (PM), load modulation, or digital modulation. Control information, such as on/off, darker/brighter, color, etc., may be information with low entropy. Thus, low-level modulation algorithms may apply. For example, amplitude modulation, also including load modulation, frequency modulation, phase modulation, as well as combinations thereof, may apply. Additionally, digital modulation techniques may be used.

In order to increase flexibility, embodiments provide modules comprising exactly one light source. In this case, each single light source may be addressed and controlled individually to increase flexibility.

Embodiments provide light sources, which are at least one of a light emitting diode (LED), an organic light emitting diode (OLED), or a thin film transistor (TFT). The light sources provide for brightness at low power consumption, and thus are well suited for large area light devices. Further, power loss is low within these light sources, and heating constraints may not apply. Other types of light sources may also be suitable and are within the scope of this patent application.

The module may be, according to embodiments, comprised of one single or a plurality (at least two) of light sources, such as LEDs, or other types of lamps. For example, a module may be comprised of 3 or 4 LEDs, thus constituting a pixel within a display. The LEDs may have different colors, thus allowing providing for creating light with any color within the color spectra of the LEDs. In this case, it is possible that each LED within the module is provided with a dedicated driving circuit. By providing more than one light source within a module, it may be possible to adjust the intensity as well as the color of the light source.

In order to provide for flexibility in the usage of the light sources, embodiments provide modules comprising a converter for converting the power supply on the electrical connection into a signal suitable for the light source. Different light sources may require different power supply, which may be accounted for using the said converter.

In order to provide scalability of the lighting devices, i.e. increasing the number of lighting devices within a large area lighting assembly, i.e. having a plurality of lighting tiles consisting of lighting devices, embodiments provide the controller to be adjustable either as master controller or as slave controller. The controllers within the lighting device may be part of a large area lighting assembly. In case more than one lighting tile is used in a system, i.e. for building large area assemblies, such as light walls in rooms, buildings, automobiles, etc., one of the plurality of the controllers acting as master controller may take over control of the other controllers, acting as slave controllers. Thus, the master controller may control the lighting assembly.

Within lighting tiles, a plurality of LEDs may be connected to modules, which are interconnected using a two-wire bus. This bus may transmit both power as well as control information for driving the modules and thus the light sources. The bus provides for reduced wiring requirements and enables a variety of lighting effects through a central controller.

Another aspect of the application is a lighting system comprising at least two lighting devices as described above, wherein one central controller is configured as master controller for controlling at least one other controller. This system allows controlling lighting devices within a large area lighting system. System controller and slave controllers may be connected via a wired or wireless connection. Communication between the master and the slave controllers may use wireless short-range communication protocols, such as Bluetooth, homeRF, WLAN, Near Field Communication (NFC) or other protocols based on ISM-frequency bands.

Another aspect of the application is a large area lighting tile with a lighting system as described above.

A further aspect of the application is a method for controlling a lighting device with providing control information and power supply from at least one controller to at least one module using one common electrical connection between the controller and the module, and driving at least one light source according to the control information.

This provides for less complexity for driving the light sources as both the power and the control information is provided using the common electrical connection.

Information specific to the light source may be provided from the module to the controller using the one common electrical connection, in case this common electrical connection is bidirectional. This is provided according to embodiments. Each module may be able to transmit light source specific information to the controller, either actively, or passively upon request. Light source information, such as temperature, light spectrum, lifetime, etc., may be detected and measured by sensors in the module and the relevant data may be stored in the modules, if necessary. It may be possible to measure the spectral information of each light source within the module separately. Further, the spectral information of the combined light of all light sources within one module may be measured. In addition, the current through or the voltage in the light source may be measured. Upon request, after certain cycles, or randomly, the gathered information may be communicated to the controller using the common electrical connection. This allows for adjusting the light output (brightness) and/or the color (spectrum) and further for fine-tuning the light sources, i.e. to account for manufacturing tolerances.

In order to allow addressing the modules, and providing the control information, embodiments provide addressing information and operation information for the modules within the control information. The addressing information may be unique for each single module, thus enabling addressing one out of a plurality of modules within a system precisely. In order to control the light output at the modules, operation information, such as commands, which define the desired condition of the light source, may be transferred. The operation information, as well as the addressing information may be coded according to an algorithm, which suit best for the needs of the respective information. By addressing each module individually, the operation of each module may be controlled from the controller individually.

Another aspect of the application is a computer program tangibly embodied in an information carrier, the computer program product comprising instructions that, when executed, cause at least one processor to perform operations comprising providing control information and power supply from at least one controller to at least one module using one common electrical connection between the controller and the module, and driving at least one light source according to the control information.

A further aspect of the application is a computer program comprising instruction that, when executed, cause at least one processor to perform operations comprising providing control information and power supply from at least one controller to at least one module using one common electrical connection between the controller and the module, and driving at least one light source according to a control information.

These and other aspects of the invention will be apparent from and elucidated with reference to the embodiments described hereinafter.

### BRIEF DESCRIPTION OF THE DRAWINGS

FIG. 1 illustrates schematically a lighting device according to embodiments;

FIG. 2 illustrates schematically a controller according to embodiments;

FIG. 3 illustrates schematically a module according to embodiments:

FIG. 4 illustrates schematically a large area lighting assembly with a plurality of tiles, each comprising a display device according to FIG. 1

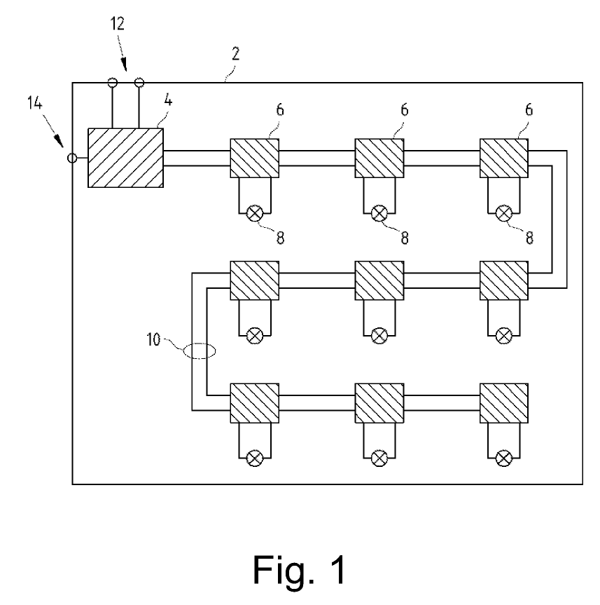

FIG. 1 illustrates schematically a lighting device 2, which may be understood as large area light tile. Lighting device 2 comprises controller 4, modules 6, light sources 8, and an electrical connection 10 being arranged as bus between the modules 6. Controller 4 is provided with a power connector 12 and a user interface connector 14.

Each lighting device 2 may be connected to a main power supply through power connector 12. This may be a 220V or 110V power supply. Further, a use of a battery, such as from automobiles, or from mobile devices is possible. The illustrated lighting device 2 may be comprised of nine light sources 8, which are driven by their corresponding modules 6. The modules 6 are connected in parallel to the bus 10. A serial connection is also possible. The number of modules 6 connected to bus 10 may be varied according to costumer needs, and depending on the size of the arrangement. Depending on the number of modules 6 connected to bus 10, the input power needs to be decreased or increased. For supplying the modules 6 and the light sources 8 with operating power, power connector 12 may be supplied with direct current (DC) or alternating current (AC), or any pulsed DC or AC waveform. The power consumption of the modules 6 and the light sources 8 may vary. Also, the overall power consumption may depend on the number of modules connected to bus 10. Therefore, different controllers 4 may be provided, which allow supplying bus 10 with different power, between several Watts up to several kW.

The power supply can be part of the lighting device 2, or provided from an external power source. For high power lighting devices 2, there is a demand for transformers providing the high power. It would not be practicable to implement the transformers within the lighting device 2. The power supply may therefore be arranged outside the lighting device 2. For low power lighting devices 2, the power supply may as well be integrated with the lighting device 2. The bus 10 can be arranged with one signal line and a common ground electrode, for instance, on a printed circuit board. This increases package density, reducing the size of the lighting device 2.

Through power connector 12 driving power may be provided to modules 6 to operate the light sources 8. In addition to the power supply, controller 8 feeds control information onto bus 10, for example by way of a high frequency signal, which may be modulated onto the power signal, already present on the bus 10. The control information may be modulated onto the bus 10 using analog or digital modulation.

The control information modulated onto bus 10 may comprise addressing information as well as operation information. Addressing information may be a unique identifier, identifying each of the modules 6 uniquely. This allows addressing each of the modules 6 independently of each other. Besides the addressing information, the operation information may be modulated onto bus 10. The operation information may comprise commands to control, for example, on/off, brightness, color, and other parameters of the light sources 8. Further, the commands can comprise requests by the controller 4 to the respective module 6 to feed back parameters about the light source 8, for instance their lifetime, their temperature, their brightness, and other information. Both, the addressing information and the operation information, can be coded according to a particular coding algorithm.

For adjusting the operation of the controller 4 and the modules 6, there is provided a user interface connector 14, allowing a user to adjust preferences and to control the controller 4. The user interface connector 14 may be wired or wireless, i.e. a serial, a parallel, or an USB-interface, as well as a WLAN, Bluetooth, homeRF, Near Field Communication (NFC) and any other interface. User interface connector 14 may also be an optical interface using infrared. By using suitable input devices 14a, the user information may be send to controller 4 in order to adjust the settings of controller 4. The status of the lighting device 2, in particular about respective modules 6 within lighting device 2, may be feed back onto user interface connector 14 in order to be processed by a computer and to be displayed on a screen.

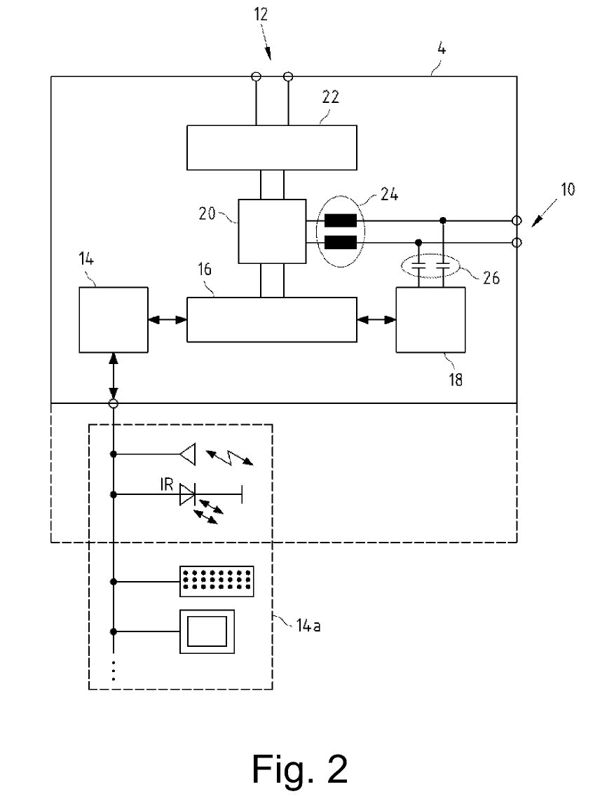

A controller 4 will be explained in more detail in FIG. 2. FIG. 2 shows a controller 4 with a power connector 12, user interface connector 14, input means 14a, microprocessor 16, modulation/demodulation circuit 18, power supply 20, voltage transformation 22, blocking inductors 24, and blocking capacitors 26. The controller 4 is connected to bus 10.

Controller 4 may be a central part of lighting device 2. In case more than one lighting device 2 is used within a system 42, as illustrated in FIG. 4, one controller 4 may be operated as master, and all other controllers 4 may be operated as slaves. The setting of master and slave function may be done automatically or user defined. The controllers 4 may be interconnected within the system 42 in order to interchange control information. This may be via wired or wireless connections.

After having set master and slave configuration of controller 4, the controller 4 operates to control the modules 6 within the corresponding lighting device 2. In order to control the modules 6, microprocessor 16 is provided, which can be a simple microprocessor, a digital signal processor, a microcontroller, or an application specific integrated circuit, or any other IC. The microprocessor 16 controls the communication between the user interface connector 14 and the modules 6. Depending on user input through input means 14a, microprocessor 16 generates control information and provides for controlling modules 6 by sending control information onto bus 10. Within the control information, microprocessor 16 provides address information and operation information. This can be done using modulation/demodulation circuit 18. Data to be sent and to be received on bus 10 is modulated and demodulated in modulating/demodulating circuit 18 and applied onto bus 10. In order to prevent DC, low frequency signals from being input into modulation/demodulation circuit 18, blocking capacitors 26 are provided, which block DC components of signals on bus 10.

Driving power is input through power connector 12. Voltage transformer 22 transforms the input power into a suitable signal to be applied onto bus 10. Power supply 20 inputs the converted power signal onto bus 10 through blocking inductors 24. Blocking inductors 24 prevent high frequency control information from being coupled into power supply 20.

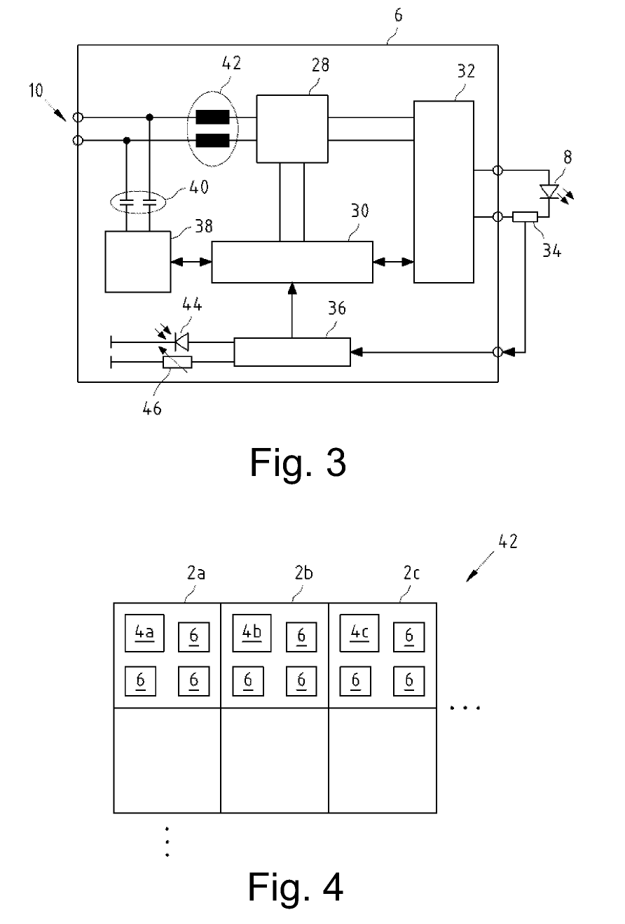

Power supplied onto bus 10, and control information supplied onto bus 10 is received within modules 6, which are coupled to bus 10. A module 6 is described in more detail in FIG. 3. FIG. 3 shows a module 6 coupled to bus 10 and driving a light source 8. Module 6 comprises a power converter 28, microprocessor 30, driving circuit 32, feedback circuit 36, modulation/demodulation circuit 38, blocking capacitors 40, blocking inductors 42, color sensitive sensor 44 and temperature sensitive sensor 46.

Power received on bus 10 is fed through blocking inductors 42 onto power converter 28. Only DC, low frequency components are received in power converter 28 and high frequency signal components are filtered by blocking inductors 42. Power converter 28 converts the received power into a suitable power for driving the driving circuit 32 and the light source 8. Control information received on bus 10 is received within modulation/demodulation circuit 38, while the DC, low frequency components, such as the power signal, are filtered by blocking capacitors 40. Depending on the received control information, modulation/demodulation circuit 38 instructs microprocessor 30 to operate driving circuit 32.

It is possible to address the module 6 individually by address information, i.e. comprises in control information. The address information is demodulated in modulation/demodulation circuit 38 and it is recognized in microprocessor 30, whether the operation information is intended for the respective module 6. Using the address information, module 6 may also feedback data about light source 8 parameters onto bus 6. This data may also be modulated in modulation/demodulation circuit 38 and fed onto bus 10.

For example, the control information may address the depicted module 6 with the operation information to change the illumination status of light source 8. This information is received in modulation/demodulation circuit 38 and fed to microprocessor 30. Microprocessor 30 instructs driving circuits 32 to increase or decrease (depending on the respective operation information) the light output of light source 8. Then the light source 8 is driven with an altered current to change its light output according to the received operation information.

Module 6 is further able to feedback information about the status of light source 8 into bus 10. A shunt transistor resistor 34 may measure the current through light source 8. Further, the brightness, color, the lifetime, or the temperature, or other information about light source 8 may be evaluated and fed to feedback circuit 36. Therefore adequate devices such as e.g. color sensitive sensor 44 and/or temperature sensitive sensor 46, etc. can be used. The measured values are processed to microprocessor 30, which instructs modulation/demodulation circuit 38 to send the respective information onto but 10. This information may be sent on a regular basis or upon request from controller 4.

The operation information may also comprise information about required color coordinates as well as required brightness of the light source 8. With this information, each module 6 may adjust the driving current of light source 8 independently in order to stay within the required color coordinates and having the required brightness. Special effects, such as creating blinking effects, or constantly increasing and decreasing the brightness or changing the color of the light source 8 may also be independently controlled by the module 6 itself, without continuously getting information from controller 4 on bus 10. Further, the constancy of a given set point may also be controlled independently via the processor by means of the feedback signals of the implemented sensors. This internal intelligence of the module 6 may reduce the requirements for the controller 4, and may result in a simplified controller 4. Information about the required operation of module 6 may be transmitted once on bus 10 and the module 6 will then take control for further evaluation and control of its associated light source 8. For example, internal timers, internal sensors, and internal logic may control the light source 8 according to the needs. The operation of the light source 8 may thereafter only be changed in case different operation information is received on bus 10.

The module 6 may be provided by an integrated circuit, allowing spatially placing the module 6 close to the light source 8, reducing the wiring and space consumption. The module 6 may also be integrated into the light source 8, for example, both the light source 8 and the module 6 may be integrated on an integrated circuit on the same substrate. Power converter 28 may be separated from the substrate, in case high power light sources are operated and heat may pose a problem.

The arrangement of lighting devices 2, as illustrated in FIG. 4, allows constructing a large area lighting assembly. This may be comprised of a plurality of lighting devices 2a-c, each comprising a controller 4, a module 6, light source 8, and a bus 10, as illustrated in FIG. 1. One of the controllers 4 may act as master, while the other controllers 4 act as slaves.

Each module 6 may be detachably connected to bus 10. In case of malfunction of a light source 8 of a module 6, the module may be replaced easily. In case the bus 10 is connected to modules 6 using ordinary two-pin connectors, replacement is particularly easy.

The lighting device 2 according to embodiments allows controlling light sources out of a plurality of light sources individually and thus realizing lighting effects within a large area lighting assembly. By addressing each light source 8 individually, a variety of effects can be provided and controlled independently. The wiring structure is simple, and the modules 6 are operated under supervision of central controller 4. This reduces wiring costs and maintenance requirements.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A lighting device comprising:
at least one controller for powering and controlling at least one module with comprising at least one light source, and
an electrical connection between the controller and the module carrying both power supply and control information between the controller and the module, wherein the controller is adjustable to be either a master controller or a slave controller within an array of a plurality of lighting devices.

2. The lighting device of claim 1, wherein the electrical connection is a bus.

3. The lighting device of claim 1, wherein at least two of the modules are connected parallel to the electrical connection.

4. The lighting device of claim 1, wherein the electrical connection is bi-directional providing transfer of control information from the controller to the module and vice versa.

5. The lighting device of claim 1, wherein the control information is provided within a high frequency signal and is modulated with at least one of:
A) frequency modulation;
B) amplitude modulation;
C) phase modulation;
D) pulse modulation;
E) load modulation; and
F) digital modulation.

6. The lighting device of claim 1, wherein the module comprises exactly one light source.

7. The lighting device of claim 1, wherein the light source is at least one of:
A) a light emitting diode;
B) an organic light emitting diode; and
C) a thin film transistor.

8. The lighting device of claim 1, wherein the module comprises a converter for converting the power supply on the electrical connection into a signal suitable for the light source.

9. (canceled)

10. A lighting system comprising at least two lighting devices of claim 1, wherein at least one central device is configured as a master controller for controlling the at least one other controller.

11. A large area lighting tile comprising a lighting system of claim 10.

12-14. (canceled)

15. A computer program product tangibly embodied in an information carrier, the computer program product comprising instructions that, when executed, cause at least one processor to perform operations comprising: providing control information and power supply from at least one controller to at least one module using one common electrical connection between the controller and the module, and driving at least one light source according to the control information, wherein the controller is adjustable to be either a master controller or a slave controller within an array of a plurality of lighting devices.

16. (canceled)
